(19) United States
(12) Patent Application Publication
(10) Pub. No.: US 2008/0122676 A1
(43) Pub. Date: May 29, 2008

(54) METHOD OF CONTROLLING THE OPERATION OF AN UWB DEVICE AND CORRESPONDING DEVICE

(75) Inventor: Friedbert BERENS, Geneva (CH)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics N.V., Amsterdam (NL)

(21) Appl. No.: 11/941,380

(22) Filed: Nov. 16, 2007

(30) Foreign Application Priority Data
Nov. 29, 2006 (EP) 06024726.9

(51) Int. Cl. H04L 17/02

(52) U.S. Cl. 341/176

(57) ABSTRACT

An ultra wide band (UWB) device includes a first control unit for controlling a UWB data stream according to a first operation mode, and a second control unit for controlling the UWB data stream according to a low duty cycle operation mode. An activation unit selectively activates the first and second control units.

### FIELD OF THE INVENTION

The invention relates to the field of communications, and more particularly, to ultra wide band (UWB) radio technology. An application of UWB radio technology is wireless personal area networks (WPAN) used to convey information over short distances among relatively few participants.

### BACKGROUND OF THE INVENTION

An example of a wireless personal area network is a piconet, which is a wireless data communications system that allows a number of independent data devices to communicate with each other. A piconet is distinguished from other types of data networks in that communications are normally confined to a person or object that typically covers about 10 meters in all directions, and surrounds the person or object, whether they are stationary or in motion.

Ultra wide band radio technology is well known and departs from conventional narrow band radio and spread-spectrum technologies in that the bandwidth of the signal is large, and typically at least 500 MHz wide. According to another definition, UWB technology is for short-range radio communications involving the intentional generation and transmission of radio-frequency energy that spreads over a very large frequency range. The radio-frequency energy may overlap several frequency bands allocated to radio communication services. Devices using UWB technology typically have intentional radiation from the antenna with either a −10 dB bandwidth of at least 500 MHz, or a −10 dB fractional bandwidth greater than 0.2 MHz.

UWB radio technology includes UWB pulsed technology. In UWB pulsed technology, instead of transmitting a continuous carrier wave modulated with information or with information combined with a spread code, which determines the bandwidth of the signal, a UWB radio transmits a series of very narrow pulses. For example, these pulses can take the form of a single cycle, or monocycle, having pulse widths less than 1 ns. These short time-domain pulses transformed into the frequency domain results in the ultra wide band spectrum of a UWB radio.

The information conveyed on the signal can be coded by a pulse position modulator (PPM). Information coding is performed by altering the timing of the individual pulses. More precisely, the series of pulses is transmitted at a repetition rate of up to several megahertz. Each pulse is transmitted within a window having a predetermined length (pulse repetition period), for example 50 ns. With respect to a nominal position, the pulse is in an early position or in a late position, which permits encoding of a logic 0 or a logic 1. It is also possible to encode more than two values by using more than two positions shifted with respect to the nominal position. It is also possible to superimpose a modulation of the BPSK type on this position modulation.

The invention is not limited to UWB pulsed technology but applies generally to UWB technology, including devices operating according to the ultra wide band (UWB) standard based on a multiband OFDM (Orthogonal Frequency-Division Multiplexing), also called MBOA (Multiband OFDM Alliance), for example. Orthogonal Frequency-Division Multiplexing (OFDM) is a method of digital modulation in which a signal is split into several narrow band channels (sub-carriers) at different frequencies.

UWB devices of the second generation (2G UWB devices) will be the only devices allowed to be sold in Europe after a date yet to be defined, which is anticipated to be around December 2010/2012. These 2G UWB devices will implement a set of mitigation techniques, such as DAA (Detect And Avoid) techniques, for example, allowing them to protect the potential victim services in the operational band between 3.1 to 4.8 GHz. These 2G UWB devices are allowed to operate within a transmission power of −41.3 dBm/MHz in the complete band between 3.1 to 4.8 GHz as long as no potential victim service is being detected. As soon as a victim service is detected within a specific band, the devices need to react accordingly by avoiding this specific band using an avoidance technique.

The regulation in Europe plans to include a phased approach for the deployment of UWB devices without DAA (1G device) in the band between 4.2 to 4.8 GHz. UWB devices without DAA will be able to use that band with an operational power of −41.3 dBm/MHz until the above mentioned date is defined.

These 1G devices can only be sold until the end of the phased approach, whereas after the phased approach, only the 2G UWB devices will be sold in Europe. However, the operation of these 1G UWB devices will nevertheless be allowed after the end of the phased approach. There is currently no approach to establish reliable communications between old 1G devices and new 2G UWB devices. Very often this missing approach is used as an argument against the phased approach.

In the U.S., the 3.1 to 10.6 GHz band is open for the deployment of UWB with a maximum operation power of −41.3 dBm/MHz without any additional restrictions like DAA or the phased approach. Again, there is currently no approach to establish reliable communications between an old 1G device operating only in the phased approach band, and a U.S. UWB device capable of operating within the full 3.1 to 4.8 GHz band. Further, there is also no approach for establishing reliable communications without interferences between a U.S. device provided with no DAA mechanism and a 2G UWB device.

### SUMMARY OF THE INVENTION

In view of the foregoing background, an object is to provide interoperability between different classes of devices in the same piconet, at least within a large portion of the 3.1 to 4.8 GHz band.

Yet another object is to reduce interference generated by non-coordinated UWB devices in a piconet.

These and other objects, advantages and features are provided by a UWB device comprising a first control unit to control operation according to a first operation mode, such as a high data rate operation mode, for example. The UWB device may further comprise a second control unit to control operation according to a low duty cycle (LDC) operation mode, and activation means or an activation unit selectively activates the first control unit or the second control unit.

Devices using ultra wide band (UWB) technology with a low duty cycle (LDC) in the 3.4 to 4.8 GHz frequency band may be intended for specific applications, which are mainly foreseen to be focused on sensor networks in homes, offices, or industrial environments. A UWB LDC device has limitations based on burst duration and burst intervals. Such a UWB LDC device is allowed in Europe without any time limit with a transmission power of −14.3 dBm/MHz in a band that is at present between 3.4 to 4.8 GHz.

By implementing the LDC mode into an existing UWB device having already a first operation mode different from the LDC mode, for example a high data rate mode or a continuous low data rate operation mode, it is advantageously possible to permit the interoperability between different classes of devices in the same piconet at least in the band 3.4 to 4.8 GHz. Of course, if the LDC operation mode is further allowed in the future in the 3.1 to 3.4 GHz band, it may be possible to permit the interoperability between different classes of devices in the same piconet within the full 3.1 to 4.8 GHz band.

Further, since the implementation of the LDC rules can be done without changing the hardware of an implementation, for example by a straightforward software upgrade, it is possible to implement this LDC operation mode even in devices (e.g., older 1G UWB devices or U.S. devices) which do not have this capability from the very beginning.

Furthermore, even phased approach devices may use an LDC operation mode to insure basic communications performance in the other bands open for the LDC operation. Further, U.S. devices can operate in Europe and can join piconets by using the LDC operation mode.

As indicated above, although the first operation mode may be a high data rate operation mode, which is generally already implemented in an existing UWB device, the operation mode may not be limited to the high data rate operation mode but can include for other conventional operation modes. Other operational modes include, for example, a low data rate continuous operation mode. More generally, the first operation mode may be a high duty cycle operation mode which might be used not only for high data rate transmissions or a continuous low data rate transmission, but also for critical QoS (Quality of Service) or real time applications, for example.

According to another embodiment, if an existing UWB LDC device is provided with another control unit for controlling the operation of the device according to another operation mode, such as a high duty cycle operation mode, and by selecting the high duty cycle operation mode, the device may operate in the phased approach band between 4.2 to 4.8 GHz at full speed.

The low duty cycle (LDC) set of regulations proposes to introduce limitations based on burst duration and burst intervals. The low duty cycle operation mode may include limitations based on emitted signal duration (burst duration) and time intervals between emitted signals (burst intervals).

The limitations based on emitted signal duration may include a maximum time duration for an emitted signal, and a maximum ratio of the sum of all emitted signals time durations relative to a given period. The limitations based on time intervals between emitted signals may include an averaged duration of a time interval between two consecutive emitted signals, and a minimum sum of all the time intervals durations per second.

The second control unit may comprise first measuring means or a first measuring unit to determine the duration of an emitted signal or burst, and second measuring means or a second measuring unit to determine the time interval between two consecutive emitted signals or bursts. The first measuring means may comprise a first counter, and the second measuring means may comprise a second counter.

According to a non-limiting embodiment, the device may comprise a MAC (medium access control) layer control processor which can include both the first and second control units. The UWB device may be a first generation (1G) UWB device further provided with the low duty cycle operation mode, for example.

According to another aspect, a method of controlling the operation of a UWB device comprises providing the device with a first operation mode and a low duty cycle operation mode, and selecting the operation mode of the device. Controlling the operation of the device in the low duty cycle operation mode may comprise determining the duration of an emitted signal, and determining the time interval between two consecutive emitted signals.

### BRIEF DESCRIPTION OF THE DRAWINGS

Other advantages and features of the invention will appear on examining the detailed description of embodiments, these being in no way limiting and of the appended drawings, in which:

FIG. 1 is a block diagram illustrating the internal protocol structure of a wireless UWB device according to the present invention;

FIG. 2 is a block diagram illustrating the internal structure of a MAC layer control processor according to the present invention;

FIG. 3 is a flow diagram illustrating a method of controlling operation of a UWB device according to the present invention;

FIG. 4 is a block diagram illustrating in greater detail implementation of an LDC operation mode according to the present invention;

FIG. 5 is a block diagram illustrating in greater detail an internal structure of a second control unit for allowing an operation of the device in accordance with the LDC operation mode according to the present invention; and

FIG. 6 illustrates an example of super frames in a WiMedia Media Access Control (MAC) according to the present invention.

### DETAILED DESCRIPTION OF THE PREFERRED EMBODIMENTS

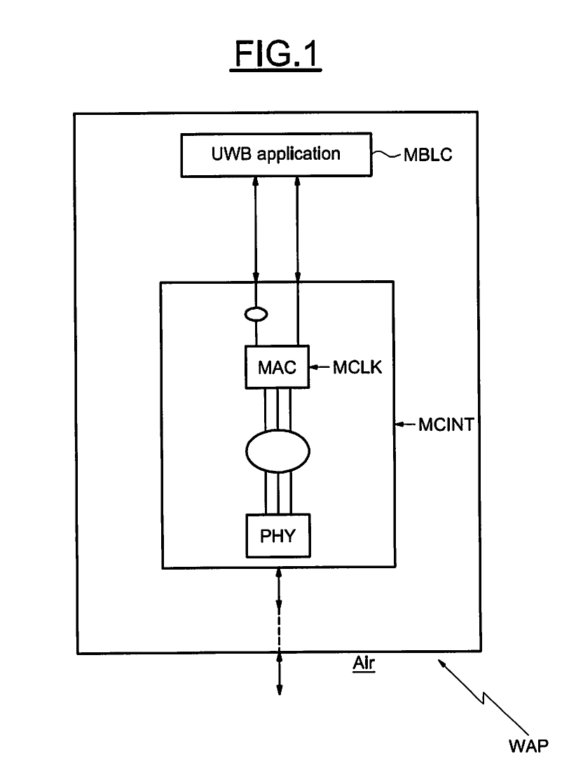

FIG. 1 discloses an example of a wireless communication device or transceiver WAP. Such a wireless UWB device WAP belongs to an OFDM based Ultra Wide Band Communication system, for example.

The wireless device WAP comprises an OFDM based UWB communication interface MCINT connected between the UWB application block MBLC and the communications medium (e.g., air). This communications interface MCINT comprises a UWB MAC layer clocked by a clock signal MCLK, and is connected to the PHY layer and to the UWB application block MBLC.

For further details concerning the MAC layer and the PHY layer of the communications interface, reference is directed to the High Rate Ultra Wide Band PHY and MAC Standard, Standard ECMA-368, 1^{st} edition, December 2005, and to the MAC-PHY Interface for ECMA-368, Standard ECMA-369, 1^{st} edition, December 2005.

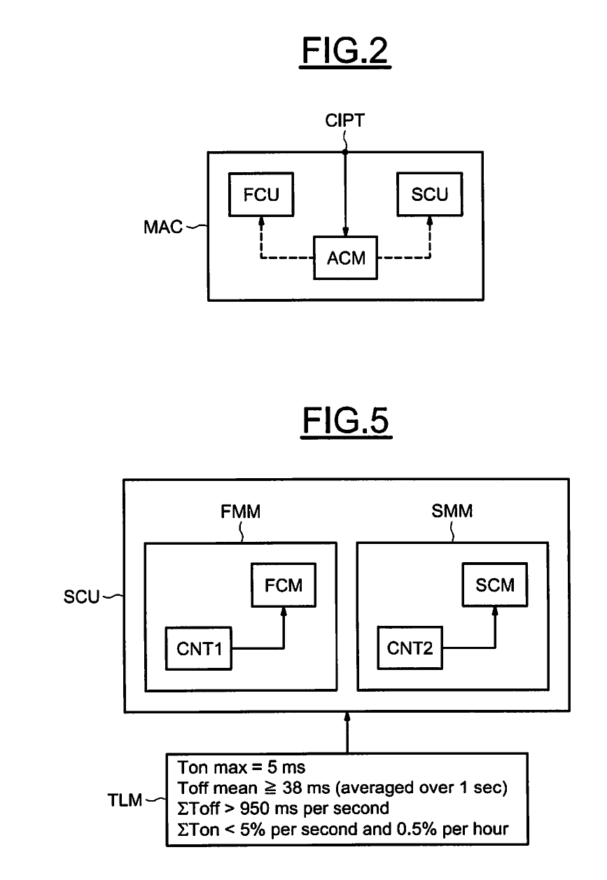

The MAC layer manages, in particular, the emission/reception of the UWB data stream according to a first operation mode, and may be incorporated by software in a first control unit (or first software module) FCU of a control processor that is globally referenced with the reference MAC in FIGS. 1 and 2.

The first operation mode is controlled by the first control unit of the MAC processor, and is a high duty cycle operation mode, for example. More particularly, it is used for high data rate transmissions (e.g., from 50 Megabits per second to 2 Gegabits per second). However, it is also possible to use this high duty cycle operation mode for a continuous low data rate transmission, or for a critical Quality of Service (QoS), or for real time applications.

The device WAP provided with the first control unit FCU which manages a conventional emission/reception of the UWB data stream according to the first operation mode, may be a 1G UWB device (first generation device) which has no DAA and operates only in the phased approach band (4.2 to 4.8 GHz) with a transmission power of −41.3 dBm/MHz.

However, this device WAP is further provided with a second control unit SCU adapted to control the operation of the device according to a low duty cycle (LDC) operation mode. This second control unit may also be implemented in software in the form of a software module.

In the present example, both of the illustrated control units FCU and SCU are incorporated within the MAC layer control processor. However, although this approach is particularly straightforward since it may be implemented by an upgrade of the existing software of the control processor MAC, other approaches are possible. These other approaches include implementing in the device a separate controller programmed for controlling the operation of the device according to the LDC operation mode, for example.

Further to the first and second control units, the device WAP also comprises activation means or an activation unit ACM adapted to activate selectively the first control unit or the second control unit. In the present example, but in a non-limiting way, the activation means ACM may also be realized by software within the control processor MAC.

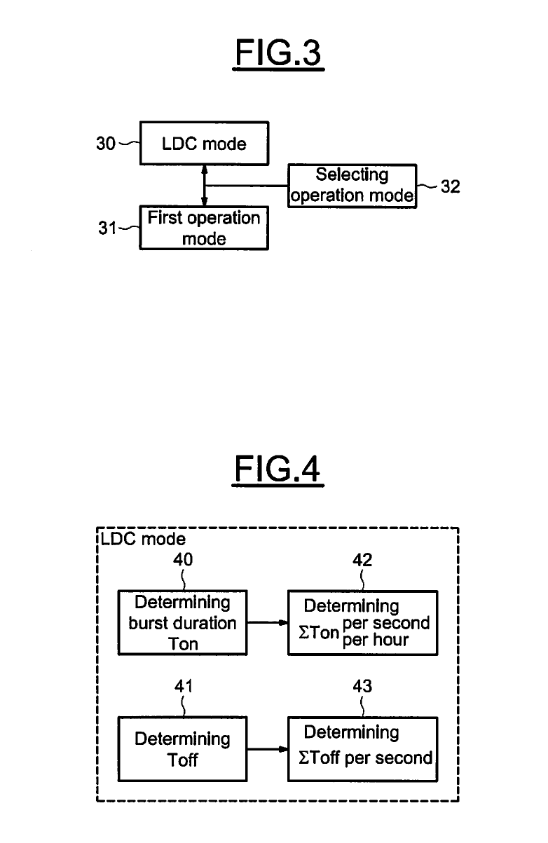

In the described embodiment, the activation means ACM is adapted to receive a command signal from an input command CIPT, and in response to this command signal, the activation means ACM activates either the first control unit or the second control unit. This command signal may come, for example, from an upper layer or from another device belonging to a piconet. The command signal directs the device WAP to switch into the LDC mode for joining the piconet, as will be explained in greater detail below. The selection of the operation mode between the LDC mode and the first operation mode is also illustrated in FIG. 3 by the steps having references 30, 31 and 32.

The band of frequencies allocated to UWB devices operating in the LDC operating mode is at present between 3.4 to 4.8 GHz with a transmission power of −41.3 dBm/MHz. This LDC mode will permit an interoperability with UWB devices (e.g., 2G devices) provided with a DAA mechanism and operating in the band 3.4 to 4.8 GHz. If in the future the band of frequencies allocated to UWB devices operating in the LDC operating mode includes also the 3.1 to 3.4 GHz band, this LDC mode will permit an interoperability with UWB devices (e.g., 2G devices) provided with a DAA mechanism and allowed to operate in the full 3.1 to 4.8 GHz band.

The low duty cycle mode includes limitations TLM (FIG. 5) based on burst duration and time intervals between bursts. A burst is an emitted signal whose time duration (Ton) is not related to its bandwidth.

Further, the time interval (Toff) is the time interval between two consecutive bursts when the UWB emission is kept idle. The duty cycle is defined as the ratio, expressed as a percentage, of the transmitter sum of all bursts duration “on” relative to a given period.

For the LDC limitation, this given period is the second and the hour. As indicated in FIG. 5, the limitations required for the LDC mode are the following:

Ton max=5 ms

Toff mean≧38 ms (averaged over 1 second)

Σ Toff>950 ms per second

Σ Ton<5% per second and 0, 5% per hour.

To comply with these time limitations, controlling the operation of the device in the low duty cycle operation mode comprises, as illustrated in FIG. 4, determining (step 40) the Ton and determining the sum of Ton per second and per hour (step 42). Further, controlling operation in the LDC mode also comprises determining the Toff (step 41), and determining the sum of the Toff per second (step 43).

For performing these steps, one approach includes providing the second control unit SCU with first measuring means or a first measuring unit FMM adapted in particular to determine the duration Ton, and with second measuring means or a second measuring unit SMM adapted in particular to determine the time interval Toff between two consecutive bursts.

The first measuring means comprises a first counter CNT1 for counting the times of access to the channel (air). From this count value, the first calculation means can determine the sum of the Ton per second and per hour, and compare the Ton max to 5 ms.

A second counter CNT2 can count the time intervals between two consecutive bursts, and the second calculation means SCM can determine the sum of the Toff per second as well as the Toff means averaged over one second.

Although such an embodiment permits the times of access to the channel (air) to be precisely determined, another approach for complying with the LDC requirements is possible. This approach comprises using the Media Access Slots (MAS) of super frames conventionally used in the WiMedia MAC protocol, as will now be explained below.

WPAN MAC protocols have a distributed nature where there is no central terminal or base station to assign the medium access. There, in contrast to a mobile radio terminal, a WPAN transceiver has a much higher flexibility to allocate the transmission slot and formats. The allocation of the communication resources is a distributed process. The allocation to a specific time slot in the super frame can be modified from one super frame to the next.

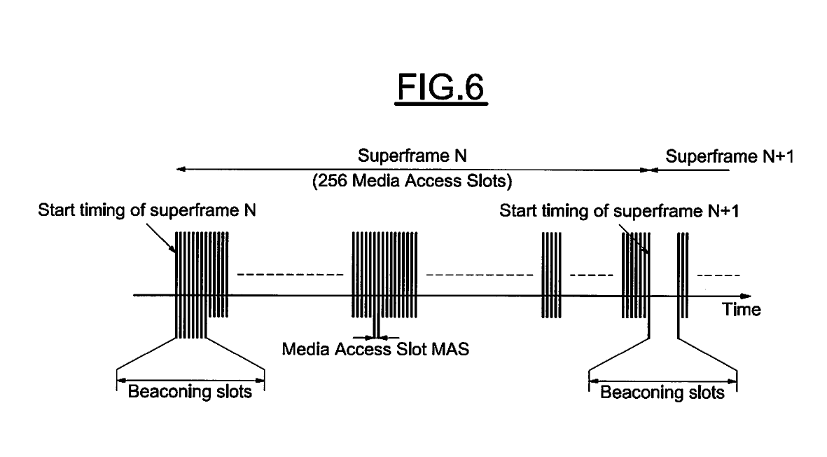

The controlling entity is the WPAN-MAC layer of the communicating terminals. The allocation is based on the requested data rate, and the type of service to be transmitted. Furthermore, the available resources are taken into account in the allocation process. The MAC layer requests a reservation for a specific time slot (Media Access Slot MAS; FIG. 6) or a number of time slots based on these constraints. These constraints can be split into local constraints, like the data rate to be transmitted or received, and network wide constraints like the already existing slot reservation.

An example of a distributed WPAN-MAC is a MBOA MAC. It is thus possible to implement within the second control unit SCU a timing scheme that allows for the fulfillment of the LDC limitations using the scheme of the WiMedia MAC illustrated in FIG. 6.

More precisely, the second control unit will, for example, reserve a beaconing slot and a single Media Access Slot for communications of the device WAP according to the LDC operation mode. If needed, up to 12 additional MAS during one second could be used. The duration of each MAS is equal to around 256 μs. By using this restriction, an average activation factor of 0.5% over one hour and 5% over one second can be implemented, thus complying with the LDC limitations.

Assuming now the existence of a WPAN network, such as a piconet, a number of independent UWB devices are allowed to communicate with each other in accordance with the WiMedia MAC protocol. The basic component of a piconet is a data independent device. Such a data independent device may be a personal computer or the like, for example.

One data independent device is required to assume the role of the piconet coordinator. The coordinator provides the basic timing for the piconet with a beacon which is part of a super frame, as illustrated on FIG. 6. The coordinator can communicate with the data independent device. Further, two data independent data devices can communicate with each other.

Assume that all the UWB devices communicating within this piconet are 2G UWB devices, and that the 1G device WAP provided with the second control unit SCU wants to join this piconet. Assume also that the 2G devices of the piconet are communicating within a band of frequencies between 3.4 to 4.2 GHz, which is outside of the phased approach band used by the 1G device WAP. To join this piconet, the WAP will send a request within one beacon slot indicating its presence, and its capability to either communicate within the phased approach band or by using an LDC mode.

If the 2G devices of the piconet have the possibility to switch into the phased approach frequencies band, and if there in no victim system in the vicinity of the piconet, communications between the 1G device WAP and the 2G devices of the piconet can be established within this phased approach frequencies band.

However, if the 2G devices of the piconet cannot switch to the phased approach frequency band, or if there is a victim system prohibiting communications within the phased approach frequency bands (since the 1G device WAP in not provided with DAA mechanism), the WAP device will receive a command signal for switching into the LDC mode. In such a case, communications between the device WAP and the piconet is possible, and without generating interferences within the victim system. It has been observed that communications in an LDC operation mode fulfills the requirements of interference avoidance towards victim systems.

1-14. (canceled)

15. An ultra wide band (UWB) device comprising:
a first control unit for controlling a UWB data stream according to a first operation mode;
a second control unit for controlling the UWB data stream according to a low duty cycle operation mode; and
an activation unit for selectively activating said first and second control units.

16. The UWB device according to claim 15, wherein the first operation mode comprises a high duty cycle operation mode.

17. The UWB device according to claim 15, wherein the low duty cycle operation mode is based on a duration of emitted signals, and time intervals between the emitted signals.

18. The UWB device according to claim 17, wherein the durations of the emitted signals include a maximum time duration for an emitted signal, and a maximum ratio of a sum of all durations of the emitted signals in a given time period, and wherein the time intervals between the emitted signals include an averaged duration of a time interval between two consecutive emitted signals and a minimum sum of all the durations per second.

19. The UWB device according to claim 15, wherein said second control unit comprises a first measuring unit for determining duration of an emitted signal, and a second measuring unit for determining a time interval between two consecutive emitted signals.

20. The UWB device according to claim 19, wherein said first measuring unit comprises a first counter, and said second measuring unit comprises a second counter.

21. The UWB device according to claim 15, further comprising a MAC layer control processor that includes said first and second control units.

22. The UWB device according to claim 15, wherein said communications interface, said first and second control units and said activation unit are configured so that the UWB device is a first generation UWB device.

23. A communications device comprising:
a physical interface; and
a medium access control (MAC) layer processor coupled to said physical interface for performing the following
controlling a UWB data stream according to a first operation mode,
controlling the UWB data stream according to a low duty cycle operation mode, and
selectively selecting the first and second operation modes.

24. The communications device according to claim 23, wherein the first operation mode comprises a high duty cycle operation mode.

25. The communications device according to claim 23, wherein the low duty cycle operation mode is based on a duration of emitted signals, and time intervals between the emitted signals.

26. The communications device according to claim 25, wherein the durations of the emitted signals include a maximum time duration for an emitted signal, and a maximum ratio of a sum of all durations of the emitted signals in a given time period, and wherein the time intervals between the emitted signals include an averaged duration of a time interval between two consecutive emitted signals and a minimum sum of all the durations per second.

27. The communications device according to claim 23, wherein controlling emission/reception of the UWB data stream according to a low duty cycle operation mode further includes determining duration of an emitted signal, and determining a time interval between two consecutive emitted signals.

28. The communications device according to claim 23, wherein said communications interface and said MAC layer processor are configured so that the communications device is a first generation UWB device.

29. A method for controlling an ultra wide band (UWB) device comprising:
using a first control unit for controlling a UWB data stream according to a first operation mode;
using a second control unit for controlling the UWB data stream according to a low duty cycle operation mode; and
selectively activating the first and second control units.

30. The method according to claim 29, wherein the first operation mode comprises a high duty cycle operation mode.

31. The method according to claim 29, wherein the low duty cycle operation mode is based on a duration of emitted signals, and time intervals between the emitted signals.

32. The method according to claim 31, wherein the durations of the emitted signals include a maximum time duration for an emitted signal, and a maximum ratio of a sum of all durations of the emitted signals in a given time period, and wherein the time intervals between the emitted signals include an averaged duration of a time interval between two consecutive emitted signals and a minimum sum of all the durations per second.

33. The method according to claim 29, wherein the second control unit comprises a first measuring unit for determining duration of an emitted signal, and a second measuring unit for determining a time interval between two consecutive emitted signals.

34. The method according to claim 33, wherein the first measuring unit comprises a first counter, and the second measuring unit comprises a second counter.

35. The method according to claim 29, wherein the UWB device further comprises a MAC layer control processor that includes the first and second control units.

36. The method according to claim 29, wherein the communications interface, and the first and second control units are configured so that the UWB device is a first generation UWB device.
